(19) United States
(12) Patent Application Publication
(10) Pub. No.: US 2007/0102055 A1
(43) Pub. Date: May 10, 2007

(54) Composites based on macro and nanoporous materials

(75) Inventors: Christopher Blair, Littleton, CO (US); Daniel L. Leeser, Framingham, MA (US); Brian R. Betty, Nashua, NH (US); Wendell E. Rhine, Belmont, MA (US); Shahrooz Zaghi, Allston, MA (US)

Correspondence Address: ASPEN AEROGELS INC.;IP DEPARTMENT, 30 FORBES ROAD, BLDG. B, NORTHBOROUGH, MA, 01532, US

(73) Assignee: Aspen Aerogels, Inc., Northborough, MA (US)

(21) Appl. No.: 11/356,308

(22) Filed: Feb. 16, 2006

Related U.S. Application Data
(60) Provisional application No. 60/657,254, filed on Feb. 23, 2005.
(60) Provisional application No. 60/755,118, filed on Dec. 30, 2005.

(51) Int. Cl. F16L 9/18

(52) U.S. Cl. 138/114; 138/148

(57) ABSTRACT

Embodiments of the present invention describe insulation systems comprising foam and nanoporous aerogel materials. Generally speaking, the insulation systems of the present invention may be employed for thermal management of essentially any surface, or volume whether enclosed fully or partially. The aerogel material(s) may reside between a foam material(s) and the region(s) to be insulated, encased partially or fully in the foam material(s) or otherwise combined therewith.

### CROSS-REFERENCES TO RELATED APPLICATIONS

This application claims benefit of priority from U.S. Provisional Patent Applications 60/657,254 (filed on Feb. 24, 2005) and 60/755,118 (filed on Dec. 30, 2005) both hereby incorporated by reference in their entirety.

### FIELD OF INVENTION

The present invention relates generally to insulation systems comprising foam and aerogel materials, and specifically those comprising fiber-reinforced aerogels.

### SUMMARY OF THE INVENTION

Embodiments of the present invention describe insulation systems comprising foam and aerogel materials. Generally speaking, the insulation systems of the present invention may be employed for thermal management of essentially any surface, or volume whether enclosed fully or partially. The aerogel material(s) may reside between a foam material(s) and the region(s) to be insulated, encased partially or fully in the foam material(s) or otherwise combined therewith. The embodiments are applicable to fluid storage/transfer systems, refrigeration units, automotive components, building and construction areas, apparel and footwear and furniture.

### DESCRIPTION OF FIGURES

FIG. 1 is an isometric view of a flow line insulated with an aerogel and foam material.

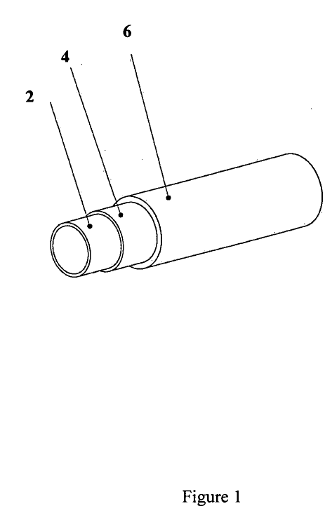

FIG. 2 is an isometric view of a pipe-in-pipe system insulated with an aerogel and foam material.

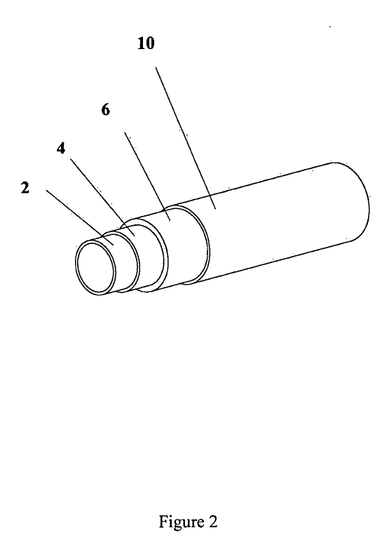

FIG. 3 is an isometric view of a flow line insulated with an aerogel and foam material and an outer coating.

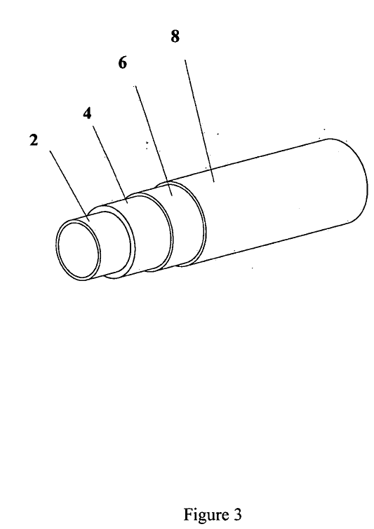

FIG. 4 is an isometric view of a pipe-in-pipe system insulated with an aerogel and foam material also comprising an outer coating.

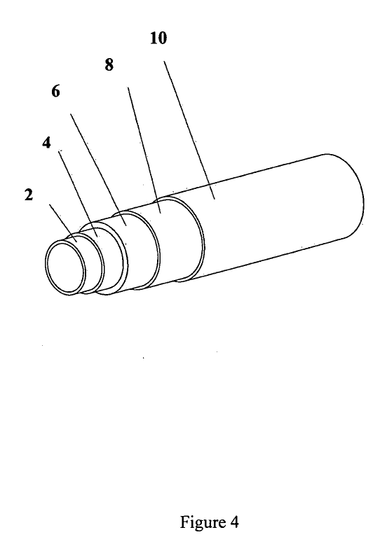

FIG. 5 is an isometric view of a flow line insulated with an aerogel material arranged between layers of foam material

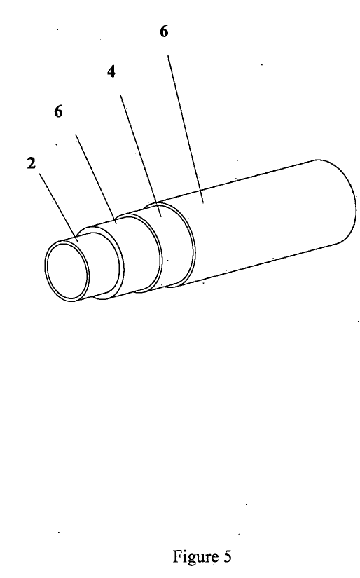

FIG. 6 is an isometric view of a pipe-in-pipe system with an aerogel material arranged between layers of foam material

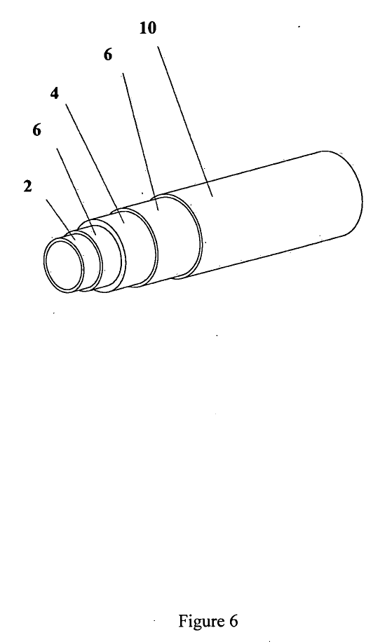

FIG. 7 is an isometric view of a flow line insulated with an aerogel arranged between layers of foam material also comprising an outer coating.

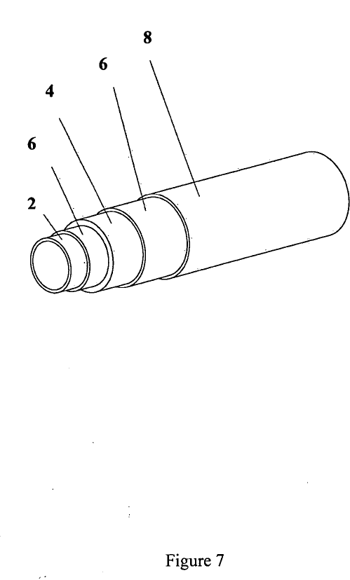

FIG. 8 is an isometric view of a flow, line insulated with an aerogel and foam material further comprising spacer(s).

FIG. 9 is an isometric view of a flow line wrapped with a spacer(s) comprising a foam and aerogel material.

### DESCRIPTION OF THE INVENTION

Aerogels materials are excellent insulators due to their low density and highly porous structure. The sol-gel process is one method for preparing gel materials, where upon drying can result in aerogels. Sol-gel process is described in detail in Brinker C.J., and Scherer G.W., Sol-Gel Science; New York: Academic Press, 1990; hereby incorporated by reference.

Within the context of embodiments of the present invention “aerogels” or “aerogel materials” along with their respective singular forms, refer to gels containing air as a dispersion medium in a broad sense, and include aerogels, xerogels and cryogels in a narrow sense. The chemical composition of aerogels can be inorganic, organic (including polymers) or hybrid organic-inorganic. Examples of inorganic aerogels include, but are not limited to silica, titania, zirconia, alumina, hafnia, yttria, ceria, carbides and nitrides. Organic aerogels can be based on compounds such as but are not limited to: urethanes, resorcinol formaldehydes, polyimide, polyacrylates, chitosan, polymethylmethacrylate, members of the acrylate family of oligomers, trialkoxysilyl terminated polydimethylsiloxane, polyoxyalkylene, polyurethane, polybutadiane, melamine-formaldehyde, phenol-furfural, a member of the polyether family of materials or combinations thereof. Examples of organic-inorganic hybrid aerogels include, but are not limited to: silica-PMMA, silica-chitosan, silica-polyether or possibly a combination of the aforementioned organic and inorganic compounds. Published U.S. patent applications 2005/0192367 and 2005/0192366 teach extensively of such hybrid organic-inorganic materials and are hereby incorporated by reference in their entirety.

Drying may be accomplished using a variety of methods known in the art. U.S. Pat. No. 6,670,402 herein incorporated by reference, teaches drying via rapid solvent exchange of solvent(s) inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 herein incorporated by reference, describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 herein incorporated by reference, discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 herein incorporated by reference describes a process whereby Resorcinol/Formaldehyde aerogels can be manufactured using a simple air drying procedure. Finally, US patent 5,565,142 herein incorporated by reference describes subcritical drying techniques. The embodiments of the present invention can be practiced with drying using any of the above techniques. In some embodiments, it is preferred that the drying is performed at vacuum to below super-critical pressures (pressures below the critical pressure of the fluid present in the gel at some point) and optionally using surface modifying agents.

Aerogels can be opacified with compounds such as but not limited to: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

Aerogels may be reinforced with fibers (or fibrous materials) resulting in a composite structure. Fibers suitable for reinforcement of aerogel materials may comprise organic polymer-based fibers (e.g. polyethylenes, polypropylenes, polyacrylonitriles, polyamids, aramids, polyesters etc.) inorganic fibers (e.g. carbon, quartz, glass, etc.) or both and in forms of, wovens, non-wovens, mats, felts, battings, lofty battings, chopped fibers, or a combination thereof. Aerogel composites reinforced with a fibrous batting, herein referred to as “blankets”, are particularly useful for applications requiring flexibility since they can conform to three-dimensional surfaces and provide very low thermal conductivity. Aerogel blankets and similar fiber-reinforced aerogel composites are described in published U.S. patent application 2002/0094426A1 and U.S. Pat. Nos.: 6,068,882, 5,789,075, 5,306,555, 6,887,563, and 6,080,475, all hereby incorporated by reference, in their entirety. Some embodiments of the present invention utilize aerogel blankets, though similar aerogel composites (e.g. those disclosed by reference) may also be utilized.

Foam materials in general describe a substance that is formed by entrapping gas bubbles in a liquid or solid. In one respect, they are distinct from gel materials (such as aerogels and xerogels) in that gel materials typically exhibit much smaller average pore dimensions. For instance, the average pore diameter for gel material is usually less than 100 nm, or less than 50 nm or less than 20 nm while that of foams are typically much higher. Furthermore, gels materials may require a separate drying step (e.g. supercritical drying) to obtain the final structures, while foams normally dry in situ. Numerous foam materials open or closed in cell structure, may be utilized throughout the embodiments of the present invention. Open-cell foams are particularly well-suited for liquid absorption and/or wicking, acoustical control, thermal management and cushioning among others properties; while closed-cell foams are particularly suited for liquid/air barriers, molding, composite fabrication, lamination, blends, cushioning and many more. Examples of suitable foam materials include but are not limited to: polyolefin foams, polyisocyanurate foams, polyurethane foams, polystyrene foams, polyvinyl chloride (PVC) foams, polymethacryalmide (PMA) foams, polypropylene (EPP) foams, polyethylene (Ethafoam) foams, phenolic foams, polyimide foams or a combination thereof. Other examples include syntactic foams and the like. Further, composite forms of foam materials may be utilized comprising particulates, fibers or both. Table 1 describes properties of some foams.

TABLE 1

| | | | Thermal | |
|---|---|---|---|---|
| | | | Conductivity | Compression |
| | Density | Open Cell | (Btu · in/ | Strength |
| Foam Type | (pcf) | Content (%) | hr · ft2 · F.) | (psi) |
| Expanded | 0.8-2.0 | 5-40 | 0.23-0.30 | 5-33 |
| Polystyrene | | | | |
| (molded) | | | | |
| Expanded | 1.4-4.0 | 1-7 | 0.20 | 15-125 |
| Polystyrene | | | | |
| (extruded) | | | | |
| Polyurethane | 1.7-3.0 | 2-10 | 0.13-0.18 | 20-60 |
| Polyisocyanurate | 1.7-3.0 | 2-10 | 0.13-0.18 | 20-60 |
| Urea Formaldehyde | 0.8-1.2 | 30-95 | 0.24 | 5 |
| Phenolic | 2.0-3.0 | 5-90 | 0.12-0.23 | 10-33 |

Embodiments of the present invention describe insulation systems comprising foam and aerogel materials. Particularly fiber-reinforced aerogels are of interest. Generally speaking, the insulation systems of the present invention may be employed for thermal management of essentially any surface, or volume whether enclosed fully or partially. The aerogel material(s) may reside between a foam material(s) and the region(s) to be insulated, encased partially or fully in the foam material(s) or otherwise combined therewith. In one respect the insulation system of the present invention is used to replace existing insulation systems that utilize foam materials. Non-limiting examples include: refrigeration units such as refrigerators, freezers, vending machines; automotive components such as front and rear seats, headrests, armrests, door panels, rear shelves/package trays, steering wheels and interior trim as well as dashboards; building and construction areas such as roofs, wall cavities, under floors; panel insulation for industrial and commercial buildings (e.g. warehouses and coldstores); apparel and footwear; furniture and bedding; fluid storage/transfer systems such as, pipes, tankers for liquid/gas hydrocarbons, liquid N₂, O₂, H₂, crude oil, etc.

Various appliances can be insulated with the present invention. One example involves freezers and refrigerators wherein: doors including around ice/water dispenser and main compartment walls/floor/ceiling are addressed. Incorporating a thermal/structural insulation as described in embodiments of the present invention will allow thinner wall sections that maximize internal volume and minimize external footprint. The system of the present invention also addresses the issue of condensation on minimum cross section areas. Another example involves ovens wherein doors and main compartment can incorporate a high temperature thermal structural insulation as described in embodiments of the present invention which allows for a thinner wall section that will operate at safe touch temperatures during the self-clean cycle. Thinner cross section allows the unit to maximize internal volume, minimize external footprint and reduce powered fan cooling times. Yet another example addresses a water heater unit. Incorporating a thermal/structural insulation to the water heater unit as per embodiments of the present invention, allows for a much more efficient water heater within the same jacket space. In yet another example a furnace unit is of interest. Incorporating high temperature thermal/structural insulation to the water heater unit as per embodiments of the present invention, allows for a much more efficient furnace within the same jacket space. Still another example addresses HVAC ducting and piping. Incorporating a thermal structural insulation to the HVAC system as per embodiments of the present invention, allows for the ducting and piping to have a much thinner insulated profile. This in-turn allows the ducting to be larger and more efficient within the allotted spacing in the construction framing.

Building sections such as house sidings may also be likewise improved. Incorporating a thermal/structural insulation, as per embodiments of the present invention, to metal and polymer siding prior to installation allows for a higher efficiency siding with minimal impact to the overall wall thickness.

In an embodiment of the present invention, foam materials (or foam material precursors) are applied via extrusion or spraying onto an aerogel material wherein the aerogel material is positioned adjacent to a surface to be insulated. For example, said surface to be insulated may be anywhere on the aforementioned appliances or building sections. Alternatively, a layer of foam material, fibrous material, or adhesive may reside between the aerogel material and the surface to be insulated. Preferably the aerogel material is fiber-reinforced. Even more preferably the aerogel material is an aerogel blanket. In a special case, pre-shaped structures comprising aerogel and foam material are mated to a surface/volume to be insulated. The aerogel material can be laminated to a foam surface prior to or post contouring. Contouring can be accomplished by foam cutting, thermoforming, compression molding, or other techniques common in the art.

In fluid storage/transfer systems that involve large volumes (e.g. tanker ships, long pipe lines) an insulation component (system) with low thermal conductivity, low density and good mechanical stability is ideal. Accordingly, an embodiment of the present invention describes an insulation system comprising both aerogel and foam materials for insulation of fluid storage/transfer systems. Said fluids may be at cryogenic, ambient or elevated temperatures and are exemplified by, but not limited to: liquid/gas hydrocarbons, liquid N₂, O₂, H₂, crude oil, etc.

In one embodiment, the system involves application of a fiber-reinforced aerogels to a pipe line. As a mode of practice, the fiber-reinforced aerogels are preferably in blanket form, though other forms may be equally suitable. The aerogel blankets may be first placed adjacent to the fluid containment area and subsequently covered with a foam material. For instance aerogel blankets can be helically wrapped about a pipe (fluid line) and secured with an adhesive tape or a shrink wrapped plastic over-layer. The pipeline may or may not be flexible. It may be desirable to use multiple plies of aerogel blankets for added insulation, with or without an interlayer(s). The interlayer may function as: slip layer (e.g. to facilitate bending), radiation barrier (metallic film, metallized polymeric film), vapor/fluid barrier, fastening mechanism (e.g. adhesive) or others. Once the aerogel material is placed, a foam material is applied to the outer surface of the outer most ply by spraying, extrusion, or fitted with a piece of pre-shaped foam. Examples of pre-shaped foams for such applications are described in U.S. Pat. No. 6,136,216 which is hereby incorporated by reference. In some instances the aerogel material is sandwiched between two layer of foam material. Likewise a foam material may be sandwiched between two layers of aerogel material. Alternatively, a foaming means is used after the foam material is applied to the aerogel blanket. Suitable foaming means include mechanical, physical and chemical foaming processes as commonly practiced in the art which may or may not require a thermal treatment step.

In a related embodiment, the fiber-reinforced aerogel layer(s) is covered partially or completely with a foam material. In one mode of practice, a layer of foam material is first placed about the pipe line, followed by wrapping (e.g. helically) with an aerogel blanket and optionally covering the blanket with a foam material.

In a manufacturing-related embodiment, pipe segments are continuously coated via spraying or extrusion of a foam material(s). This may be carried out in sync or in separate steps with wrapping of the pipe with an aerogel material. The foam may be applied before, after (or both) an aerogel material is placed. Preferably the aerogel material is in blanket form and is helically wrapped. This allows for further automation of the process.

In another related embodiment a fiber-reinforced aerogel layer(s) is cast into or on at least one surface of a piece of pre-shaped foam. Preferably at least one layer of aerogel material is cast onto the foam surface immediately adjacent to the pipe line. A non-limiting example involves pouring a gel precursor solution into a foam material so shaped as to contain said precursor or positioned in a mold designed to permit the same. The subsequent steps include inducing(or allowing) gellation, aging (optional) and drying as previously prescribed or as is commonly practiced.

In a related embodiment, a fibrous layer is adhered to, or partially infused in a foam material such that at least a portion of the fibrous layer is free for infiltration of a liquid therein. Accordingly, a gel precursor is poured into the available portion of the fibrous layer. As before, the subsequent steps include inducing (or allowing) gellation, aging (optional) and drying as previously prescribed or as is commonly practiced. The fibrous layer may be in the form of a mat, felt, batting, web or other commonly manufactured fiber forms.

In another embodiment, the foam material is formed around an aerogel material. For instance, the aerogel material may be placed in a mold and subsequently encapsulated fully or partially when the mold is filled with a foam material. The aerogel material is preferably fiber-reinforced, more preferably a blanket.

In yet another related embodiment, the aerogel material (preferably an aerogel blanket) is fastened to at least one surface of a piece of pre-shaped foam. Suitable fastening mechanisms include but are not limited to chemical or mechanical fasteners such as adhesives, double sided adhesive tapes, staples, pins and the like.

In another embodiment the present invention is applicable to pipe-in-pipe designs. Pipe-in-pipe designs typically comprise a flow line which conveys fluids, said fluid line residing within a carrier pipe wherein an annular space exists between the two. In such designs, typically centralizers (or spacers) are installed on the flow line for a various reasons such as to facilitate insertion into the carrier pipe, or maintaining the annular space. However, spacers can create a thermal bridge in these designs. Therefore, replacement of the centralizers with foam essentially removes the thermal shunting effect of the spacers in some cases. Additionally, foam materials provide added insulation, abrasion resistance, and mechanical stability to aerogel insulated flow lines particularly, where large sections are involved possibly in S-laying, J-laying or reeling. In one embodiment a fiber-reinforced aerogel layer(s) is first placed about the flow line, secured as in the previous embodiments, and is subsequently covered or coated with a foam material. The foam material may be applied before the flow line is inserted into the carrier pipe or after.

Another embodiment involves a pipe-in-pipe design with spacers. The teachings of the previous embodiments may be employed to construct pipe lines of this variety. For instance a spacer may be helically wrapped along with an aerogel material (or in a separate step) and subsequently covered with a foam material. Additionally a foam material may be applied about the flowline before wrapping with spacers and aerogel materials.

In one embodiment, the foam material is coated with a polymeric material for a variety of reasons such as, but not limited to abrasion resistance, chemical resistance, fluids/moisture/air barrier, insect resistance, flame/heat protection, radiation protection (e.g. UV), addition of physical features (e.g. modify surface topography) and many others. For instance high density or highly cross-linked polymeric materials whether thermoplastic or thermosetting may be used.

In an embodiment, the foam materials have a moisture permeability of less than 10 perms, less than 5 perms, less than 1 perm or preferably less than 0.1 or even preferably less than 0.01 perm.

In another embodiment the aerogel materials exhibit a thermal conductivity of less than about 25 mW/mK, less than about 20 mW/mK, less than about 15 mW/mK or less than about 12 mW/mK.

In a non-limiting example, a layer of aerogel blanket is wrapped and secured about a pipe line. Next, a coating of low density polyurethane foam (2-6 pcf) is applied to the blanket. The thickness of the coating is at least about 0.5 inches. The foam is applied by spraying or extrusion. Optionally, the exterior of the foam is coated with a high density polyurethane coating (outer coating). The density of the coating is greater than 6 pcf, preferably greater than 40 pcf. This pipe line may be operational as is or be inserted into a carrier pipe as in a pipe-in-pipe configuration.

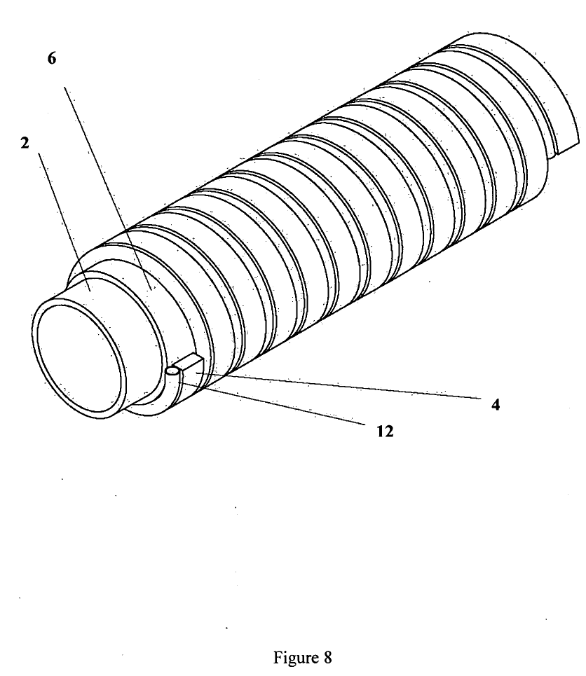

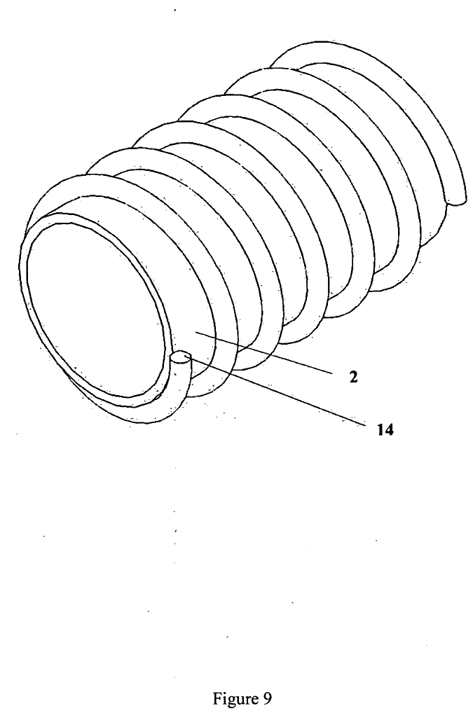

The appended figures merely serve to aid understanding of some embodiments of the present invention and do not limit the scope of the present invention as a whole in any manner. Accordingly a flow line 2 is shown that can be insulated with at least one layer of aerogel material 4 and at least one layer of foam material 6. In a pipe-in-pipe configuration, a carrier pipe 10 is included. In some instances an outer coating 8 may be applied to the outer most surface of the aerogel material or foam material. In some instances spacers 12 may be employed in addition to the aerogel and foam materials. In still other cases composite spacers 14 comprising both aerogel and foam materials are employed. Although spacers are portrayed as helical in FIGS. 8 and 9, discrete rings or blocks may be equally used.

What is claimed is:

1. A pipe-in-pipe system comprising:
a carrier pipe;
a flow line positioned within said carrier pipe so as to create an annular space between the flow line and carrier pipe; and
a fiber-reinforced aerogel material and a foam material both disposed within said annular space;

2. The system of claim 1 wherein the aerogel material is encased in the foam material.

3. The system of claim 1 wherein the aerogel material resides between the foam material and the flow line.

4. The system of claim 1 further comprising spacers.

5. The system of claim 1 wherein the spacers comprise a foam material and an aerogel material.

5. A pipe line comprising:
a flow line; and
a fiber-reinforced aerogel material and a foam material both disposed about said flow line.

6. The pipe line of claim 5 wherein the aerogel material is encased in the foam material.

7. The pipe line of claim 5 wherein the aerogel material resides between the foam material and the flow line.

8. A method of insulating a surface of interest comprising the steps of:
placing a fiber-reinforced aerogel material adjacent to said surface of interest; and covering said aerogel material with a foam material.

9. The method of claim 8 wherein the aerogel material is encased in a foam material.

10. The method of claim 8 further comprising a step of adhereing the aerogel material to said surface of interest.

11. An insulated structure comprising a shaped form comprising a fiber-reinforced aerogel material and a foam material.

13. The structure of claim 11 wherein the aerogel material is partially encased in the foam material.

14. The structure of claim 11 wherein the aerogel material fully incased in the foam material.

15. The structure of claim 11 wherein the aerogel material is adhered to at least one surface of the foam material
